(19) United States
(12) Patent Application Publication
(10) Pub. No.: US 2004/0071828 A1
(43) Pub. Date: Apr. 15, 2004

(54) Method for preparing an energy food product having a physiologically functional ingredient

(75) Inventors: Jamie Troy, Columbia, NJ (US); Edward L. Rapp, Blairstown, NJ (US); Ralph Lee, Hampton, NJ (US); Jeannette Dido, Hoboken, NJ (US); Douglas Mann, Belvidere, NJ (US); Thomas Collins, Nazareth, PA (US); Kevin Rabinovitch, Hackettstown, NJ (US)

Correspondence Address: FITZPATRICK CELLA HARPER & SCINTO, 30 ROCKEFELLER PLAZA, NEW YORK, NY, 10112, US

(73) Assignee: Mars, Incorporated, McLean, VA

(21) Appl. No.: 10/272,618

(22) Filed: Oct. 15, 2002

(51) Int. Cl. A23L 1/30

(52) U.S. Cl. 426/72

(57) ABSTRACT

The present invention is a method for preparing an energy food product. The method comprises the steps of (a) applying a functional component to a surface of a food substrate, wherein the functional component comprises at least one physiologically functional ingredient; and (b) applying a flowable edible material to substantially cover the functional component.

### BACKGROUND OF THE INVENTION

1. Field of the Invention

This invention is directed to a method of preparing an energy food product, such as an energy bar, having at least one physiologically functional ingredient. After applying the physiologically functional ingredient to a food substrate, the physiologically functional ingredient is covered with a flowable edible material to minimize sensory detection of the physiologically functional ingredient.

2. Related Background Art

Food products that identify themselves as energy food products are gaining in popularity among all consumers. The thought of eating a nutritious food product that is shelf stable and packaged in a portable form is appealing to most people, especially individuals who feel they need a functional benefit from the nutrients offered by such products. Other products, such as for example, granola bars and fruit snacks have gained in popularity by offering consumers natural food ingredients that are perceived to be nutritious.

However, the energy food products that are currently marketed are typically bars, which are made by mixing formulation ingredients to form a homogeneous mass. The mass is then either extruded or molded to form bar shape pieces that are dried or solidified to form the final product piece. Many of these products do not appeal to many consumers, who prefer more food like properties. Moreover, the homogeneity of the bar/extruded mass provides for a product that has a singular taste. This can lead to less than optimal tasting products since functional ingredients, which often have undesirable taste attributes, are mixed in with other components thereby degrading the overall taste of the product. This leaves many of the presently marketed products with an unappealing taste, which causes many consumers to avoid them. A more appealing alternative is needed to provide consumers with the nutritional or functional benefits they seek in a format that consumers find desirable with sensory variation and variety.

### SUMMARY OF THE INVENTION

The present invention is a method for preparing an energy food product comprising the steps of (a) applying a functional component to a surface of a food substrate, wherein the functional component comprises at least one physiologically functional ingredient; and (b) applying a flowable edible material to substantially cover the functional component.

In one embodiment, the method for preparing an energy food product comprises the steps of (a) applying a first flowable edible material to a surface of a food substrate; (b) applying a functional component onto a surface of the first flowable edible material, wherein the functional component comprises at least one physiologically functional ingredient; and (c) applying a second flowable edible material to substantially cover the functional component.

In another embodiment, the method for preparing an energy food product comprises the steps of (a) forming a substantially homogeneous mixture by combining a flowable edible material and a functional component, wherein the functional component comprises at least one physiologically functional ingredient; and (b) applying the homogenous mixture to a surface of a food substrate.

In still yet another embodiment, there is an energy food product comprising a food substrate having a flowable edible material on a surface of the substrate, and at least one physiological functional ingredient dispersed in the flowable edible material, wherein the physiologically functional ingredient is selected from the group consisting of vitamins, minerals, fiber, antioxidants, herbal supplements, polyphenols, and mixtures thereof.

### BRIEF DESCRIPTION OF THE DRAWINGS

FIG. 1 is a block flow diagram showing a mixing operation that combines a flowable edible material with a functional component; and

FIG. 2 is a block flow diagram showing one embodiment of the present invention, where a layering process is utilized.

### DETAILED DESCRIPTION OF THE INVENTION

For the purposes of the present invention, energy food products are food products that are shelf stable, in a portable form, and based on a 55 g serving size provides about 2 to about 55 g of carbohydrates, about 1 to about 5 g of fortification components (e.g., vitamins, minerals, antioxidants, herbs, etc.), about 5 to about 40 g of protein, about 2 to about 8 g of fat, about 170 to about 300 calories, and has a moisture content of at least about 3% by weight.

In addition, for the purposes of the present invention, the use of the term “functional” is understood to mean a physiologically functional ingredient.

The present invention provides a method for preparing an energy food product having at least one physiologically functional ingredient. The first step involves applying a functional component to the surface of a food substrate, wherein the functional component comprises a physiologically functional ingredient. In the second step, a flowable edible material is applied to substantially cover the functional component containing the physiologically functional ingredient.

In one embodiment, the method involves the steps of: applying a first flowable edible material to a surface of a food substrate. Then applying a functional component to a surface of the first flowable edible material. The functional component includes at least one physiologically functional ingredient. This is followed by applying a second flowable edible material to substantially cover the functional component. The first flowable edible material may be the same material or a different material from the second flowable edible material.

In another embodiment, an energy food product having at least one physiologically functional ingredient is made according to the following method. A flowable edible material and a functional component are combined, creating a homogenous mixture. The homogenous mixture is then applied to a surface of a food substrate.

The functional component is comprised of at least one physiologically functional ingredient. Optionally, it may include a carrier, processing aids, or combination thereof.

The physiologically functional ingredient is an essential component of the energy food product of the present invention and is included to provide a physiological benefit, such as providing nutrients. Suitable physiologically functional ingredients include, but are not limited to, vitamins, minerals, fiber, antioxidants, herbal supplements, polyphenols, and the like. The vitamins and/or minerals can also be fat soluble and/or water soluble. In addition, the physiologically functional ingredient can also be an amino acid, enzyme, and the like.

The preferred vitamins are for example, vitamin A, vitamin C, vitamin D, vitamin E, vitamin K, and their derivatives and/or pro-vitamins. Preferred vitamins also include B vitamins such as, for example, biotin, folic acid, niacin, niacinamide, pantothenate, pyridoxine hydrochloride, riboflavin, thiamin hydrochloride, and the like. The preferred minerals include but are not limited to bromine, calcium, chromium, copper, iodine, iron, magnesium, manganese, phosphates, phosphorus, potassium, selenium, sodium, sulfur, and zinc.

Additionally, other physiologically functional ingredients include, for example, amino acids such as arginine, histidine, isoleucine, leucine, lysine, methionine, phenylalanine, threonine, tryptophan, valine, alanine, aspartic acid, glutamic acid, glutamine, glycine, serine, tyrosine, creatine, and the like. Moreover, the physiologically functional ingredients may be phytochemicals, sterols, lycopine, herbal supplements such as ginseng, guarana, yerba mate, and the like.

In addition, the functional component may include a carrier component, processing aid, or mixture thereof. Suitable carrier components are, for example, chocolate, compound coatings, liquid oils, solid fats, glycerin monostearate, mono- and di-glycerides, flow agents, and the like. Preferred flow agents include starch, tricalcium phosphate, carboxy methyl cellulose, cellulose, and the like. When flow agents or processing aids are included in the functional component, it may be useful to encapsulate the physiologically functional ingredients.

Various techniques may be used to apply the functional component onto the food substrate or first flowable edible material. Suitable methods include slabbing (applying a layer), spraying, gravity deposition, electrostatic deposition, and the like. These methods are particularly preferred when the functional component is in powder form.

The physiologically functional ingredient is included in the functional component in an amount of at least about 20 wt. %, preferably at least about 60 wt. %, and more preferably at least about 90 wt. %, based on the total weight of the functional component.

The amount of the functional component that will be added will depend upon product design requirements. In one embodiment, the functional component is about 0.1 wt. % to about 10 wt. % and preferably from about 0.1 wt. % to about 5 wt. % of the total weight of the energy food product.

The energy food product has a food substrate to which either a functional component or a flowable edible material is applied. The food substrate may be, for example, a protein-based substrate, a carbohydrate-based substrate, and combinations thereof.

The protein-based substrate provides nutrients that help with the growth and repair of body tissues. For adults, many dietary guidelines recommend that a person consume approximately 0.6 g of protein per kilogram of body weight per day. Higher levels are recommended for individuals that are more physically active. In addition, protein can be used as a source of energy. One gram of protein provides about 4 kcal of energy. The protein based substrate includes, but is not limited to, whey protein, milk protein, egg protein, casein, peanut flour, nut meats, vegetable protein, and combinations thereof. Vegetable proteins include, for example, soy protein, peanut protein, hazelnut protein, and the like. The carbohydrate-based substrate may be, for example, grain based, nougat based, corn syrup based, and the like.

The flowable edible material may be applied onto the food substrate or over the functional component, or combined with the functional component to form a homogenous mixture. It is primarily used to trap, cover, or encase the functional component that contains the physiologically functional ingredient. Non-limiting examples of the flowable edible materials, e.g., first or second flowable edible materials, are fat based materials such as compound coatings or chocolate, syrups, film-forming edible barriers, and the like. Syrups that are suitable for use, include, carbohydrate based syrups such as sucrose syrup, corn syrup, caramel, and the like. Film-forming edible barriers include, for example, carboxy methyl cellulose, alginate, and the like.

Enrobing, panning, extruding, spraying, depositing, and any other suitable technique may be used for applying the flowable edible material or homogeneous mixture.

In a particularly preferred embodiment, the present invention is an energy food product comprising a food substrate having a flowable edible material on a surface of the substrate, and a functional component that contains at least one physiological functional ingredient dispersed in the flowable edible material. The functional component includes a fortification ingredient selected from the group consisting of vitamins, minerals, protein, fiber, antioxidants, herbal supplements, polyphenols, and mixtures thereof.

When combined with the flowable edible material, the functional component is about 2 wt. % to about 20 wt. %, preferably from about 5 wt. % to about 20 wt. %, and more preferably from about 5 wt. % to about 10 wt. %, based on the total weight of the flowable edible material and functional component mixture.

In a preferred embodiment, product stability and shelf life are ensured by designing the energy food product so that the total moisture content is less than about 15 wt. %, and preferably from about 3 wt. % to about 12 wt. %, based upon the total weight of the energy food product. The water activity of the energy food product is ideally less than about 0.6, and preferably less than about 0.5.

The energy food products of the present invention may also contain additional ingredients known to those skilled in the art in order to provide an organoleptically acceptable final product for consumption. For example, additional ingredients may include natural and artificial flavors, sweeteners, fruits, salt, flavor enhancers, flavor masking agents, bulking agents, color additives, emulsifiers, stabilizers, fats, preservatives, and the like.

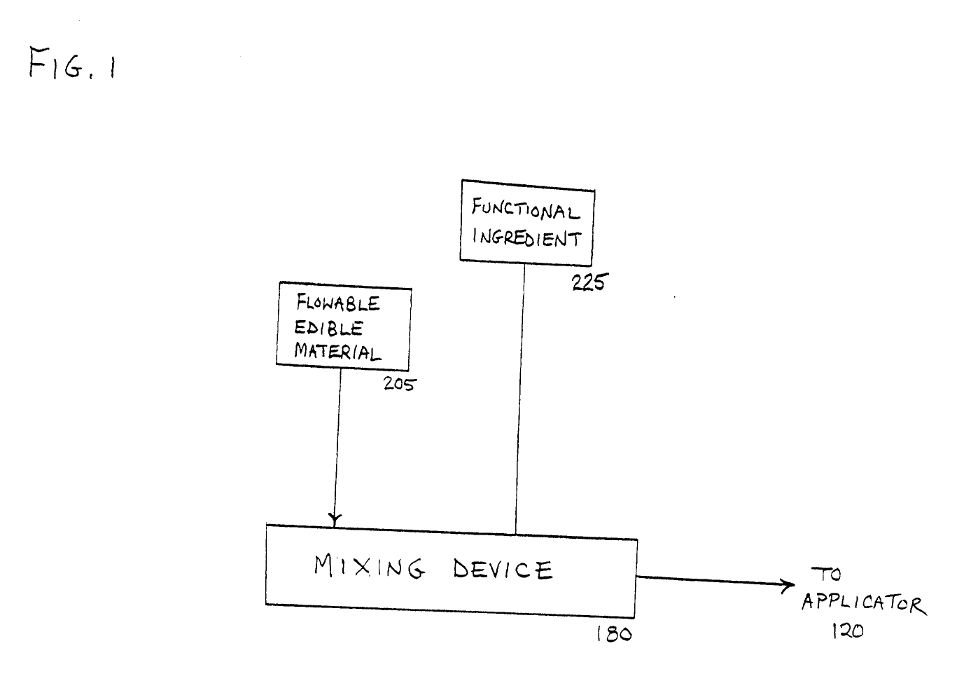

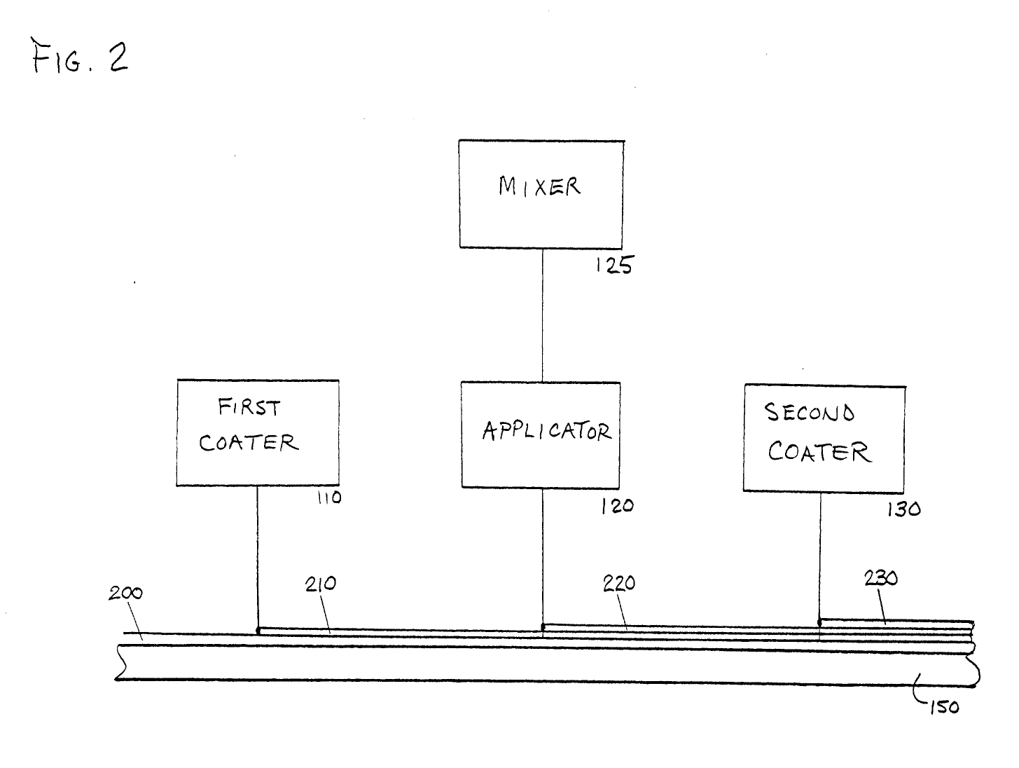

Referring to the figures, FIG. 1, shows a mixing operation that combines functional component 225 with a flowable edible material 205, such as chocolate. The two ingredients are mixed in mixing device 180, which feeds the ingredients to an applicator such as the one shown in FIG. 2.

FIG. 2 depicts one embodiment of the present invention that includes a forming process that is used to manufacture an energy food product. Food substrate 200 moves along conveyor 150. First coater 110 deposits first flowable edible material 210, e.g. chocolate, onto the food substrate. Middle layer 220 is then deposited on top of the first flowable edible material, from applicator 120. The middle layer contains a functional component 225 comprising at least one physiologically functional ingredient, e.g., a vitamin blend, that is mixed in mixer 125. Second coater 130 then applies second flowable edible material 230, e.g. chocolate, on top of the middle layer, thereby covering the functional component.

### EXAMPLE 1

TABLE 1
Pre Blend Mixture
Ingredient

| | |
|---|---|
| Corn Syrup | Consisting of one or more ingredients selected from the |
| Blend | list of: High Fructose, Corn Syrup, Honey and |
| | 63 DE corn syrup |
| Protein | Consisting of one or more ingredients selected from the |
| Blend | list of: Vegetable or Animal Protein, Whey Protein |
| | Isolate, Calcium Caseinate, Soy Protein Isolate and |
| | peanut flour or their derivatives |
| Salt | Artificial and/or Natural flavors such as vanillin, |
| Flavorings | cinnamon and cocoa powder |

TABLE 2

| Component | Percent by Weight |
|---|---|
| Pre Blend Mixture | 80.0 |
| Soy Crisps | 20.0 |
| | 100.0 |

The ingredients as set forth in Table 1 are mixed in a Z-blade batch style mixer to produce a pre blend mixture. Soy crisps are then added to the pre blend mixture in the ratio as set forth in Table 2 and mixed to produce an energy food substrate.

The energy food substrate is cooled and formed into a slab using forming rolls. The slab produced is 8 mm high.

A functional component containing minerals, vitamins, and other desired nutritional supplements is then sprinkled onto the top surface of the slab. This step is followed by spreading a compound coating over the top of the slab, covering the functional component and a portion of the slab of energy food substrate. The slab is then further cooled, slit, cut into bar shapes, and packaged.

### EXAMPLE 2

An energy food substrate is prepared and formed into a slab as set forth in Example 1. A layer of a compound coating is applied to the surface of the slab prior to the application of the functional component. This provides a sticky surface to which the functional component can adhere. The functional component, e.g., mixture of vitamins, minerals, and other desired nutritional supplements is sprinkled onto the compound coating. Another layer of the compound coating is applied over the functional component, thereby sealing in the functional component. The slab is then further cooled, slit, cut into bar shapes, and packaged.

### EXAMPLE 3

An energy food substrate is prepared and formed into a slab as set forth in Example 1. A functional component is mixed with a compound coating. The compound coating with the functional component is then applied onto the top surface of the slab. The slab is then further cooled, slit, cut into bar shapes, and packaged.

### EXAMPLE 4

An energy food substrate is prepared and formed into a slab as set forth in Example 1. A functional component is blended with a fluid caramel, which is then applied to the top surface of the slab. Afterwards, the slab is cooled and coated with a compound coating. The slab is then further cooled, slit, cut into bar shapes, and packaged.

### EXAMPLE 5

An energy food substrate is prepared and formed into a slab as set forth in Example 1. The slab is cooled, slit, and cut into the shape of bars. A functional component is mixed with a compound coating. The compound coating with the functional component is then applied to individual bars in an enrober. The enrobed bars are then cooled and packaged.

### EXAMPLE 6

An energy food substrate is prepared and formed into a slab as set forth in Example 1. A functional component containing cocoa polyphenols is applied by sprinkling the functional component onto the surface of the slab. The slab is then coated with chocolate, sealing in the functional component. The slab is then further cooled, slit, cut into bar shapes, and packaged.

### EXAMPLE 7

An energy food substrate is prepared and formed into a slab as set forth in Example 1. The slab is cooled, slit, and cut into the shape of bars. A functional component is then applied to the bars by mixing the functional component with a carrier such as canola oil and sprayed onto the bars. The bars are then cooled and enrobed in a compound coating. Additional cooling is applied and then the bars are packaged.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method for preparing an energy food product comprising the steps of:
(a) applying a functional component to a surface of a food substrate, wherein said functional component comprises at least one physiologically functional ingredient; and
(b) applying a flowable edible material to substantially cover said functional component.

2. The method according to claim 1, wherein said physiologically functional ingredient is selected from the group consisting of vitamins, minerals, fiber, antioxidants, herbal supplements, polyphenols, and mixtures thereof.

3. The method according to claim 1, wherein said flowable edible material is a fat based material selected from the group consisting of compound coatings, chocolate, and mixtures thereof.

4. The method according to claim 1, wherein said flowable edible material is a syrup.

5. The method according to claim 1, wherein said flowable edible material is a film-forming edible barrier selected from the group consisting of carboxy methyl cellulose, alginate, casein, and mixtures thereof.

6. The method according to claim 1, wherein said food substrate is selected from the group consisting of a protein based substrate, a carbohydrate based substrate, and mixture thereof.

7. The method according to claim 6, wherein said food substrate is a carbohydrate based substrate selected from the group consisting of grain based, nougat based, and corn syrup based.

8. The method according to claim 6, wherein said food substrate is a protein-based substrate selected from the group consisting of milk protein and vegetable protein.

9. The method according to claim 1, wherein said functional component further comprises a carrier component selected from the group consisting of chocolate, compound coatings, liquid oils, solid fats, glycerin monostearate, mono- and di-glycerides, flow agents, and mixtures thereof.

10. The method according to claim 1, wherein said functional component further comprises a processing aid.

11. The method according to claim 1, wherein said physiological functional ingredient is at least about 90 wt. % of the functional component.

12. The method according to claim 1, wherein said functional component is a powder that is applied by spraying, gravity deposition, or electrostatic deposition.

13. The method according to claim 1, wherein said flowable edible material is applied by enrobing, panning, extruding, spraying, slabbing, or depositing.

14. A method for preparing an energy food product comprising the steps of:
(a) applying a first flowable edible material to a surface of a food substrate;
(b) applying a functional component onto a surface of said first flowable edible material, wherein said functional component comprises at least one physiologically functional ingredient; and
(c) applying a second flowable edible material to substantially cover said functional component.

15. The method according to claim 14, wherein said physiologically functional ingredient is selected from the group consisting of vitamins, minerals, fiber, antioxidants, herbal supplements, polyphenols, and mixtures thereof.

16. The method according to claim 14, wherein said first or second flowable edible material is selected from the group consisting of a fat based material, a syrup, and a film-forming barrier.

17. The method according to claim 16, wherein said first or second flowable edible material is a fat-based material selected from the group consisting of compound coatings, chocolate, and mixtures thereof.

18. The method according to claim 14, wherein said first or second flowable edible material is selected from the group consisting of a syrup and a film-forming edible barrier.

19. The method according to claim 14, wherein said food substrate is selected from the group consisting of a protein based substrate, a carbohydrate based substrate, and mixture thereof.

20. The method according to claim 14, wherein said functional component further comprises a carrier component selected from the group consisting of chocolate, compound coatings, liquid oils, solid fats, glycerin monostearate, mono- and di-glycerides, flow agents, and mixtures thereof.

21. The method according to claim 14, wherein said functional component further comprises a processing aid.

22. The method according to claim 14, wherein said physiological functional ingredient is at least about 90 wt. % of the functional component.

23. The method according to claim 14, wherein said functional component is a powder that is applied by spraying, gravity deposition, or electrostatic deposition.

24. The method according to claim 14, wherein said first or second flowable edible material is applied by enrobing, panning, extruding, spraying, slabbing, or depositing.

25. A method for preparing an energy food product comprising the steps of:
(a) forming a substantially homogeneous mixture by combining a flowable edible material and a functional component, wherein said functional component comprises at least one physiologically functional ingredient; and
(b) applying said homogenous mixture to a surface of a food substrate.

26. The method according to claim 25, wherein said physiologically functional ingredient is selected from the group consisting of vitamins, minerals, fiber, antioxidants, herbal supplements, polyphenols, and mixtures thereof.

27. A method according to claim 25, wherein said flowable edible material is selected from the group consisting of a fat based material, a syrup, and a film-forming edible barrier.

28. A method according to claim 27, wherein said flowable edible material is a fat-based material selected from the group consisting of compound coatings, chocolate, and mixtures thereof.

29. The method according to claim 25, wherein said food substrate is a protein based substrate, a carbohydrate based substrate, or mixture thereof.

30. The method according to claim 25, wherein said functional component further comprises a carrier component selected from the group consisting of chocolate, compound coatings, liquid oils, solid fats, glycerin monostearate, mono- and di-glycerides, flow agents, and mixtures thereof.

31. The method according to claim 25, wherein said functional component further comprises an effective amount of a processing aid.

32. The method according to claim 25, wherein said physiological functional ingredient is at least about 90 wt. % of the functional component.

33. The method according to claim 25, wherein said homogeneous mixture is applied by enrobing, panning, extruding, spraying, slabbing, or depositing.

34. An energy food product comprising:
food substrate having a flowable edible material on a surface of said substrate, and
at least one physiological functional ingredient dispersed in said flowable edible material, wherein said physiologically functional ingredient is selected from the group consisting of vitamins, minerals, fiber, antioxidants, herbal supplements, polyphenols, and mixtures thereof.
